(19) United States
(12) Patent Application Publication
(10) Pub. No.: US 2003/0123688 A1
(43) Pub. Date: Jul. 3, 2003

(54) Sound-damping laminate system

(76) Inventors: David H Cox, Chatsworth, CA (US); Bernard M Werner, Los Angeles, CA (US); William J Gelow, Thousand Oaks, CA (US)

Correspondence Address: SONNENSCHEIN NATH & ROSENTHAL, P.O. BOX 061080, WACKER DRIVE STATION, CHICAGO, IL, 60606-1080, US

(21) Appl. No.: 09/521,522

(22) Filed: Mar. 8, 2000

(51) Int. Cl. H04R 1/02; H04R 1/20

(52) U.S. Cl. 381/353; 381/340

(57) ABSTRACT

For loudspeaker components with flat and/or curved panel-like regions that require hard surfaces along with sound-damping properties to minimize sound feed-through and resonances, a three-layer laminate is formed from two surface layers of commercially available thermosetting molding compound, co-molded in a single molding operation with an embedded core of suitable sound damping material such as filled vinyl copolymer compound or filled silicon rubber compound. The core region is dimensioned to leave a peripheral margin in which the two layers of molding material become bonded together so as to fully encapsulate and seal the sound-damping core. Furthermore, the margin can be made to have any desired size, thickness or shape to also serve as a mounting, fastening or other function of the component.

### PRIORITY

Benefit is claimed under 35 U.S.C. §119(e) of pending provisional application No. 60/123,351 filed Mar. 8, 1999.

### FIELD OF THE INVENTION

The present invention relates to the field of audio loudspeakers and more particularly it relates to structure of such loudspeakers where sound damping properties are required in panel-like regions that require stiffness.

### BACKGROUND OF THE INVENTION

In the design and manufacture of audio loudspeakers there are typically regions in horns, waveguides and special enclosure structures that are panel-like, i.e. fairly constant in thickness whether flat or curved, where stiffness and hard surfaces are required for mechanical and/or acoustic purposes, but where acoustic damping is required for sound absorption, deadening and isolation between the two opposite surfaces of the panel-like region. As an example, in the throat portion of a horn loudspeaker, the internal surface is exposed to a field of high energy sound pressure, while at the opposite surface at the exterior of the horn, sound vibrations are unwanted due to their potential influence on the directivity and overall acoustic performance. Usually the problem relates to one or more resonance effects within the audio frequency range as determined by physical concentrations of mass and compliance.

A basic approach to this type of problem is to make the parts thicker and thus more massive and rigid, however this approach may require unacceptable increases in weight, cost and size.

In an alternative approach, damping material can be deployed strategically to suppress resonant effects by lowering the Q of the mechanical resonance and thus causing a portion of the unwanted acoustic energy to be dissipated by conversion into heat energy rather than transmitted to the interior and exterior surfaces then emanated as acoustic radiation.

It is relatively easy to apply damping material to exterior surfaces. A coating of adhering, flexible, elastic or visco-elastic material can be formulated and applied to provide the required balance of stiffness, mass and damping; however this approach is generally unacceptable due to reliability problems as ell as aesthetic and marketing disadvantages in the field of endeavor of the present invention.

### DISCUSSION OF RELATED KNOWN ART

U.S. Pat. No. 5,519,178 to Ritto, assigned to Southern California Sound Image, Inc., discloses a lightweight speaker enclosure with laminated flat regions having a seamless rigid skin facing outwardly, a middle sound absorbing cellular layer, and a seamless flexible skin facing inwardly in the enclosure. Pre-impregnated thermo-plastic materials are utilized in a sequential lay-up process with no heat or pressure applied.

U.S. Pat. Nos. 4,308,782 and 4,362,081 by Henry, assigned to Remo, Inc., disclose three layer laminated heads, for drums or similar musical instruments, with plastic sheet material in the outer layers and, respectively, in the core for damping effect, random fiber synthetic fabric material or non-impregnated synthetic woven fabric material.

Suppression of noise in automobiles has received a great deal of attention and study, including the suppression of engine noises radiating from the oil pan, as addressed in the following patents:

U.S. Pat. Nos. 4,952,610 and 5,143,755 to Moore et al, assigned to Soundwich, Inc., disclose respectively structure and method of constrained layer sound damping for reducing noise from housings such as oil pan for automobiles. A noise-damping composition of rubbery polyurethane intermixed with olefin polymer is sandwiched between the metal oil pan housing and a metal liner, inserted by an activated blowing agent.

U.S. Pat. No. 4,599,926 to Hart et al, assigned to Shell Oil Company, discloses a metal-polymer-metal structural laminate with a polymeric resinous core providing light weight, sound damping, polymer-metal adhesion, high stiffness and high heat tolerance for automotive paint oven bake stability.

### OBJECTS OF THE INVENTION

It is a primary object of the present invention to provide damping within panel-like regions of audio loudspeaker components including flat and/or curved regions of horns, waveguides, enclosures and covers which require hard surfaces on the panel-like regions, but which require attenuation of through-panel sound transmission and suppression of resonances.

It is a further object to provide a method of producing a sound-damping panel structure that enables balancing the properties of stiffness, mass and damping, along with capability of selectively addressing potential resonant frequencies in particular structural configurations.

It is a further object that the sound-damping structure be producible economically in a simple process from commercially available materials.

It is a further object to make the structure solid in perimeter regions and yet sound-damping in major regions within the perimeter, such that the sound-damping core material is effectively sealed in place.

### SUMMARY OF THE INVENTION

The above-mentioned objects have been accomplished by the present invention of a three-layer laminate wherein, in a preferred embodiment, the two surface layers are made of commercially available thermosetting molding compound such as SMC (sheet molding compound) or equivalent in bulk or thick versions, and are co-molded in a single molding operation with a core of mineral-filled damping material, typically deployed in a panel region surrounded by a margin containing exclusively the thermosetting molding compound extending inwardly a predetermined width from the outer perimeter of the component part. This margin can be molded in various shapes and thickness and is thus able to serve both as a seal to retain the core material and as a relatively thick mounting or fastening region for the panel or part involved.

The core material is selected from a group of sound damping materials including principally a filled vinyl copolymer compound or a filled silicon rubber compound. Balsa wood, corrugate and foam are potentially functional for this purpose but have not proven sufficiently uniform and stable.

### BRIEF DESCRIPTION OF THE DRAWINGS

The above and further objects, features and advantages of the present invention will be more fully understood from the following description taken with the accompanying drawings in which:

FIG. 1 is a top view of a component part of a horn loudspeaker, made in accordance with the present invention from standard molding compound to have a flat panel region laminated with a sound-damping core extending between specially-shaped homogeneous end regions.

FIGS. 1A and 1B are cross-sections taken through 1A-1A′ and 1B-1B′ of FIG. 1, respectively, showing the sound-damping core region.

### DETAILED DESCRIPTION

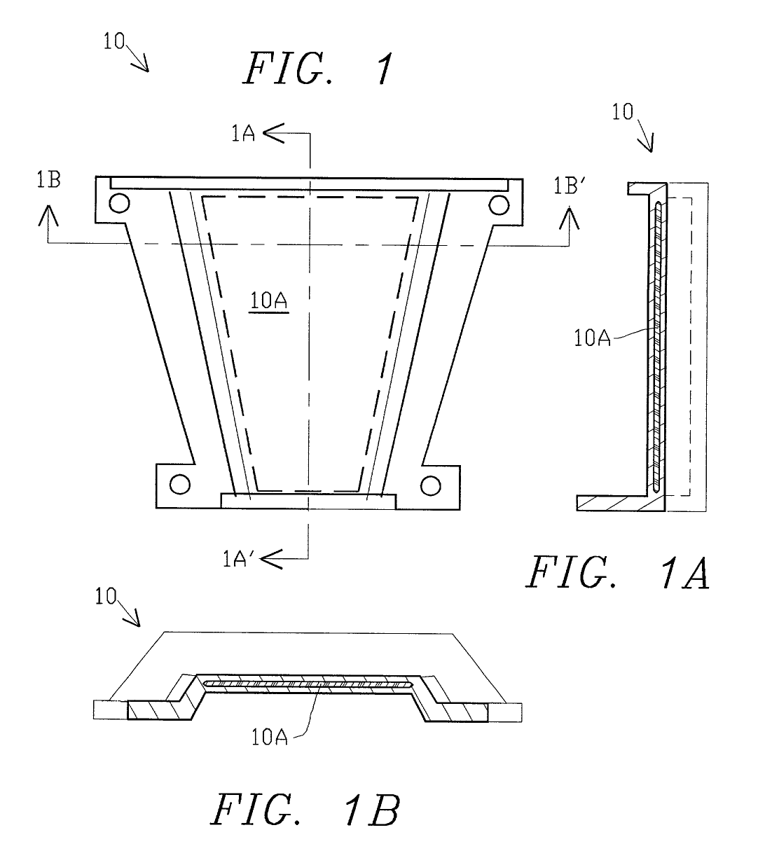

FIG. 1 is a top view of an exemplary horn loudspeaker component part 10 having a flat region 10A that extends to the area within the dashed outline wherein a three-layer laminated structure includes a core of sound-damping material in accordance with the present invention.

FIG. 1A and FIG. 1B are cross-sections of part 10 taken through 1A-1A′ and 1B-1B′ respectively of FIG. 1, showing the sound-damping core 10A as the central layer of a three-layer laminate in the flat region of part 10, wherein the two surface layers and the end regions of part 10 are of standard thermosetting molding compound which is commercially available in uncured bulk, thick and sheet form (SMC: sheet molding compound).

In the process of molding a loudspeaker part such as part 10, three layers are laid in a mold: (1) a first uncured surface layer of thermosetting molding compound, (2) the sound-damping core 10A, extending only to the area to be sound-damped, and (3) a second uncured surface layer of thermosetting molding compound, along with any additional small pieces that may be required for build-up in the end regions. Heat and pressure are applied to flow-mold and thermoset the molding material in a single molding process. The additional steps itemized in the following method claims are preparatory steps; the actual molding process itself thermosets and bonds the entire laminated component in a single operation.

In the molding process, the panel-like region containing core 10A becomes a three-layer laminate while surrounding regions, or at least two opposite edge regions, each become integrated into a single homogeneous mass of cured molding material which serves both as a peripheral seal to retain the material of core 10A and as a functional flange, mounting or attachment region for component 10.

In an exemplary typical horn structure the three layers in the laminated region of core 10A are made to have equal thickness, e.g. each 0.125″ thick for a total thickness of 0.375″.

The edge regions, which are to consist entirely of thermosetting molding material, can be formed from sheet, bulk or thick thermosetting molding material and can molded to any thickness within a working range and to a variety of different shapes by appropriate mold design and configuration along with initial mold loading built up with extra pieces of molding material if and as required.

The molding material in the two outer layers is typically a thermosetting resin such as epoxy (polyether) resin or a polyester resin in a styrene monomer, filled with fiberglass, commercially available in such forms as SMC (sheet molding compound), LPMC (low pressure molding compound), bulk molding compound and thick molding compound, for processes such as compression molding, resin transfer molding and rim molding.

The invention may be embodied and practiced in other specific forms without departing from the spirit and essential characteristics thereof. The present embodiments are therefore to be considered in all respects as illustrative and not restrictive, the scope of the invention being indicated by the appended claims rather than by the foregoing description; and all variations, substitutions and changes which come within the meaning and range of equivalency of the claims are therefore intended to be embraced therein.

What is claimed is:

1. A method, in the manufacture of loudspeaker components with hard surfaces and having panel-like regions that can include flat and curved portions, of embedding sound-damping material within the panel-like regions, comprising the principal step of:
applying heat and pressure from a molding machine to an uncured layered stack including a first surface layer and a second surface layer, both of uncured molding material and having similar outlines, enclosing therebetween a core layer of sound-damping material of smaller outline, thus defining a peripheral margin of direct interface between the first and second surface layers, the pressure being made such as to press the first and second surface layers together in interfacing contact in the peripheral margin, and the heat being made such as to cause the first and second surface layers to become cured and bonded together in the peripheral margin, thus embedding the core layer between the first and second surface layers.

2. The method of embedding sound-damping material as defined in claim 1 further comprising the preliminary steps of:
(1) preparing the first and second surface layers to have the desired similar overall outlines;
(2) preparing the core layer of sound-damping material to have a desired outline smaller than the overall outlines;
(3) laying the first surface layer into the molding machine;
(4) laying the core layer onto the first layer, positioned so as to define the peripheral margin of uncured molding material; and
(5) laying the second surface layer on the core layer and the first surface layer, substantially in outline registration with the first surface layer, preparatory to applying heat and pressure as in claim 1,

3. The method of embedding sound-damping material in loudspeaker components as defined in claim 1 wherein the uncured molding material comprises a thermosetting resin with fiberglass reinforcement.

4. The method of embedding sound-damping material in loudspeaker components as defined in claim 1 wherein the sound-damping material is selected from a group of sound-damping materials including a filled vinyl copolymer compound and a filled silicon rubber compound.

5. The method of embedding sound-damping material in loudspeaker components as define in claim 2, further comprising in step 4, the additional substep of:
(4a) laying additional amounts of uncured molding material as required in the peripheral margin.

6. A loudspeaker component having a panel-like region, which may include flat and curved portions, structured with hard surfaces of molding material and containing an embedded core of sound-damping material, comprising:
a first surface layer of molding material made to have a predetermined boundary outline;
a core layer of sound-damping material made to have a predetermined outline smaller than that of said first layer so as to form a peripheral margin of molding material; and
a second surface layer of molding material, having an outline similar to that of said first layer and located in substantial registration therewith, bonded to said first layer in the peripheral margin so as to form a sealed core region containing said core layer.

7. The loudspeaker component as defined in claim 6 wherein the molding material is a commercially available thermosetting resin with fiberglass reinforcement.

8. The loudspeaker component as defined in claim 6 wherein said core material is selected from a group of sound-damping materials including a filled vinyl copolymer compound and a filled silicon rubber compound.
